(19) United States
(12) Patent Application Publication
(10) Pub. No.: US 2025/0229478 A1
(43) Pub. Date: Jul. 17, 2025

(54) Apparatus and method for producing plastics material preforms comprising temperature measurement of the produced plastics material preforms

(71) Applicant: KRONES AG, Neutraubling (DE)

(72) Inventors: Jochen FORSTHOEVEL, Regensburg (DE); Ralf URBAN, Teugn (DE); Christian TILSNER, Hochheim/Main (DE)

(21) Appl. No.: 19/021,966

(22) Filed: Jan. 15, 2025

(30) Foreign Application Priority Data
Jan. 15, 2024 (DE) 102024101053.3

(51) Int. Cl. B29C 49/78; B29C 49/28; B29C 49/64; B29K 67/00; B29L 31/00

(52) U.S. Cl. CPC B29C 49/786; B29C 49/28; B29C 49/648; B29C 2049/7861; B29K 2067/003; B29L 2031/7158

(57) ABSTRACT

An apparatus for producing plastics material containers has a production device having a plurality of production units, each of which is configured for producing plastics material preforms from a plastics material mass, a forming device having a plurality of forming stations, and at least one transport device for transporting the plastics material preforms separately from the production device to the forming device, at least in portions. The apparatus further has a first temperature detection device for detecting a temperature of individual plastics material preforms produced by the production device, and at least one assignment device for assigning, to a plastics material preform whose temperature has been detected, the production unit that produced the plastics material preform and/or the forming station that will form the plastics material preform into a plastics material container.

### BACKGROUND OF THE INVENTION

The present invention relates to an apparatus and a method for producing plastics material containers and, in particular, plastics material bottles. Such apparatuses and methods have long been known from the prior art. It is known that plastics material preforms are first heated and then formed into plastics material containers in devices such as blow molding machines.

In the meantime, machines have become known in which the production plant also has a production device, such as an injection molding machine, that produces these plastics material preforms. The aim is to directly process the warm plastics material preforms produced by the production device in order to save on energy used to heat the plastics material preforms.

DE 10 2016 118 670 A1 discloses a method and an apparatus for checking preforms. Preforms or plastics material preforms are transported and thermal images of these preforms are taken.

An optical inspection system for plastics material preforms is known from WO 2018/036857 A1.

The present invention is based on the object of improving the control of such apparatuses.

### SUMMARY OF THE INVENTION

An apparatus according to the invention for producing plastics material containers has a production device for producing plastics material preforms, wherein these plastics material preforms are suitable and intended for being formed into plastics material containers. Furthermore, the production device has a plurality of production units, each of which is suitable and intended for producing plastics material preforms from a plastics material composition or from a plastics material (in particular in a flowable state).

Preferably, each of these production units is suitable for producing exactly one single plastics material preform. The production unit is therefore preferably a forming tool that is suitable and intended for producing one single plastics material preform. The production device is, in particular, an injection molding machine.

Furthermore, the apparatus has a forming device that is suitable and intended for forming the plastics material preforms produced by the production device into the plastics material containers, wherein the forming device has a plurality of forming stations, each of which is suitable and intended for applying a flowable medium and, in particular, a gaseous medium and, in particular, compressed air to the plastics material preforms in order to form them into the plastics material containers.

Furthermore, the apparatus has at least one transport device that is suitable and intended for transporting the plastics material preforms separately from the production device to the forming device, at least in portions, wherein the apparatus further has a first inspection device and/or temperature detection device that is suitable and intended for detecting a temperature of individual plastics material preforms produced by the production device (in particular in a spatially resolved manner).

Preferably, the temperature detection device or inspection device is suitable and intended for detecting the temperature of a first region of the plastics material preforms in a spatially resolved manner.

According to the invention, the apparatus further comprises at least one assignment device that is suitable and intended for assigning, to a plastics material preform whose temperature has been detected, the production unit that produced said plastic material preform and/or the forming station that will form said plastics material preform into a plastics material container.

For example, an image of several plastics material preforms can be taken and the plastics material preforms shown in this image can be assigned to the individual production units or forming stations. It would also be conceivable that images of individual plastics material preforms are assigned and that these plastics material preforms are then assigned to the production units and/or forming stations.

Preferably, the apparatus has a memory device in which the images recorded by the image recording device are stored at least temporarily.

It is therefore proposed to detect the temperature of the plastics material preforms and, in particular, to control the production device and/or the forming device using this temperature and, in particular, to control parameters that are characteristic of the production and/or the forming.

This allows for dynamic control of parameters of the forming device and/or the production device. The parameters of the forming device can be, for example, the pre-, intermediate or final blowing pressure, the time curve of the pressure profile around a temperature/temperatures, and/or a temperature profile/distribution around a stretching rod movement, or cooling in a heating module and the like.

The parameters of the production device can be, for example, an after pressure time, an injection pressure, an injection flow, an injection profile, an injection temperature, a switching volume, an injection speed, a mass temperature, a mold temperature, a screw speed, a back pressure or a switching point, a temperature control of the after-cooler unit or the like.

In general, the energy consumption in the heating module of the stretch blow molding machine can be reduced through the targeted use of residual heat from the injection molding process. In addition, a larger process window and thus more stable operating behavior is achieved because fluctuations can be compensated for. This can open up further possibilities for lightweighting plastics material containers produced using the stretch blow molding process.

In a preferred embodiment, the forming device is a blow molding machine and in particular a stretch blow molding machine. Preferably, the forming device has a movable and, in particular, rotatable carrier on which the forming stations are arranged.

Preferably, the forming stations in each case have rod-like bodies, in particular so called stretching rods, which can be inserted into the plastics material preforms in order to stretch them in their longitudinal direction. Furthermore, the forming stations preferably each have valve blocks that allow the plastics material preforms to be exposed to a flowable medium and in particular to compressed air and in particular to different pressures.

Particularly preferably, the temperature detection device is arranged along the transport path along which the plastics material preforms are transported from the production device to the forming device. Preferably, the (first) temperature detection is therefore arranged between the production device and the forming device. Particularly preferably, the transport device is suitable and intended for detecting the temperature of the plastics material preforms and/or at least one value that is characteristic of the temperature of the plastics material preforms, and, in particular, to detect it during a movement of the plastics material preforms.

Furthermore, the apparatus preferably has a temperature control device for controlling the temperature of the produced plastics material preforms and, in particular, a cooling device for cooling the produced plastics material preforms. Preferably, this cooling device is suitable and intended for cooling a predetermined number of plastics material preforms simultaneously.

In a preferred embodiment, the production device has at least 20, preferably at least 30, preferably at least 40, preferably at least 50, preferably at least 80 and preferably at least 100 production units. Preferably, the production device has at most 200, preferably at most 180 and preferably at most 160 production units.

These production units can be arranged on a common carrier. Preferably, these production units are aligned in the same way, so that the plastics material preforms produced therein are preferably also aligned in the same way and/or are aligned parallel to one another.

In a further advantageous embodiment, the forming device has at least 4, preferably at least 8, preferably at least 10 and preferably at least 20 forming stations. In a further preferred embodiment, the forming device has at most 100, preferably at most 80 and particularly preferably at most 60 forming stations.

In a further advantageous embodiment, the first temperature detection device has at least one image recording device, in particular a camera and in particular a thermal imaging camera. Particularly preferably, the first temperature detection device comprises a plurality of first thermal imaging cameras. Preferably, these image recording devices and, in particular, thermal imaging cameras are arranged along a line that runs obliquely or, in particular, perpendicularly to a transport path of the plastics material preforms.

In a further advantageous embodiment, the apparatus has a second temperature detection device that is suitable and intended for detecting the temperature of a second region of the plastics material preforms, wherein the first region of the plastics material preforms and the second region of the plastics material preforms differ from one another.

In a further advantageous embodiment, the apparatus has an inspection device that is suitable and intended for detecting at least one characteristic value that is characteristic of the plastics material preform and/or in particular a characteristic value that is characteristic of a second region of the plastics material preform.

Preferably, this characteristic value is selected from a group of characteristic values that contains a geometry of the plastics material preform, a color of the plastics material preform, a humidity of the plastics material preform, the intrinsic viscosity (IV value of the plastics material preform), a temperature of the plastics material preform, a stress pattern and the like.

Particularly preferably, the first region of the plastics material preforms is a mouth region of the plastics material preforms. Particularly preferably, the second region of the plastics material preforms is a main body of the plastics material preforms and preferably the region that is formed by the forming device. Said mouth region is preferably not formed by the forming device.

In a further advantageous embodiment, the apparatus has a heating device arranged between the production device and the forming device, which heating device is suitable and intended for heating the plastics material preforms produced by the production device, in particular at least in portions.

Preferably, this heating device has a transport device for transporting the plastics material preforms and at least one heating device for heating the plastics material preforms.

The transport device is preferably configured as a circulating transport chain on which a plurality of holding devices and, in particular, holding mandrels for holding the plastics material preforms are arranged. Preferably, this heating device also has a rotating device that rotates the plastics material preforms with respect to their longitudinal axis during heating.

Preferably, the heating devices are infrared heating devices that irradiate the plastics material preforms with infrared radiation in order to heat them. However, it would also be conceivable that the heating device is a microwave heating device that heats the plastics material preforms using microwaves.

In a further advantageous embodiment, the apparatus has a further second inspection device and/or temperature detection device that is suitable and intended for detecting a temperature of the plastics material preforms heated between the production device and the forming device and/or by the heating device, wherein said further temperature detection device is preferably suitable and intended for detecting the temperature of the plastics material preforms in a spatially resolved manner at least in the longitudinal direction of said plastics material preforms.

In particular, said further temperature detection device is suitable and intended for detecting the temperature of individual plastics material preforms.

Said further temperature detection device can be designed as a plurality of pyrometers that are arranged one above the other in the longitudinal direction of the plastics material preforms. However, it is particularly preferred that this further temperature detection device is also configured as an image recording device and, in particular, as a thermal imaging camera that records an image or a thermal image of the plastics material preforms and/or is suitable and intended for this purpose.

In a further advantageous embodiment, the apparatus has a further assignment device in order to assign forming stations to the plastics material preforms transported and/or heated by the heating device, in particular those forming stations that will heat said plastics material preforms. In addition, this assignment device can also assign production units to the plastics material preforms detected by the further temperature detection device.

In a further preferred embodiment, the transport device that transports the plastics material preforms from the production device to the forming device or in the direction of the forming device has a movable carrier that has a plurality of receiving means for receiving the plastics material preforms in the same orientation.

For example, said transport device can have a tray that has a plurality of recesses, each of which is suitable and intended for receiving individual plastics material preforms.

Particularly preferably, the transport device has at least two different transport means for transporting the plastics material preforms. Preferably, at least one of these transport means is selected from a group of transport means which includes transport starwheels, transport chains, conveyor belts and the like.

Preferably, at least one of these transport means has gripping devices for gripping the plastics material preforms. These gripping devices can be, for example, gripping clamps or holding mandrels.

Preferably, at least one temperature detection device and preferably both temperature detection devices are arranged on a transport path of said carrier and preferably allow for separate temperature detection of the individual plastics material preforms.

In a further advantageous embodiment, the at least one transport device is suitable and intended for continuously transporting the plastics material preforms separately from the production device to the forming device. This means that, in particular on the transport path between the production device and the forming device, it is always possible to assign each transported plastics material preform to the production unit which produced this plastics material preform and/or to the forming station which will form this plastics material preform into a plastics material container.

In this way, an assignment of certain plastics material preforms to the production units and/or the forming stations can be maintained. In this way, control of both the production device and/or the forming device can be achieved taking into account the individually detected temperatures of the individual plastics material preforms. It would be possible for the temperature of each individual plastics material preform transported to be detected, but it would also be possible, for example, to detect only the temperature of every nth plastics material preform.

In a further advantageous embodiment, the production units each have marking devices that are suitable and intended for providing the produced plastics material preforms or the plastics material preforms to be produced with a marking that is characteristic at least of the production unit that produced the plastics material preform in question. For example, such markings can be applied to the support rings of said plastics material preforms. This can happen, in particular, during the production process of the plastics material preforms.

In a further advantageous embodiment, the apparatus has at least one inspection device which is suitable for determining at least one characteristic value for the plastics material preforms, wherein this characteristic value can preferably also be assigned to the production unit which produced this plastics material preform and/or to the forming station which will form this plastics material preform into a plastics material container.

The present invention is further directed to a method for producing plastics material containers, wherein a production device produces plastics material preforms, wherein these plastics material preforms are suitable and intended to be formed into plastics material containers. Furthermore, the production device has a plurality of production units, each of which produces the plastics material preforms from a plastics material mass (and/or from a plastics material that is flowable during production).

The plastic material is preferably PET.

Furthermore, a forming device forms the plastics material preforms produced by the production device into the plastics material containers and in particular plastics material bottles, wherein the forming device has a plurality of forming stations, each of which applies a flowable medium (and in particular a gaseous medium) to the plastics material preforms in order to thus form them into the plastics material containers.

Furthermore, at least one transport device transports the plastics material preforms from the production device to the forming device, at least in portions. Furthermore, a first temperature detection device is provided that detects a temperature of individual plastics material preforms produced by the production device (and/or values characteristic of such a temperature).

Preferably, the first temperature detection device detects the temperature of a first region of the plastics material preforms (in particular in a spatially resolved manner and in particular in a spatially resolved manner at least in a longitudinal direction of the plastics material preforms).

According to the invention, at least one assignment device is further provided which assigns to a plastics material preform whose temperature has been detected by the first temperature detection device, the production unit that produced said plastics material preform and or the forming stations which forms said plastics material preform form into a plastics material container. It is possible that a (mean) temperature of each plastics material preform or of a region of each plastics material preform is detected, but it would also be possible for the temperature to be detected in a spatially resolved manner within said region (such as a mouth region or a main body).

Particularly preferably, a second temperature detection device detects a temperature of a second region of the plastics material preforms. Preferably, at least one temperature detection device and preferably both temperature detection devices detect the temperature of the first and/or second region of the plastics material preforms during a transport movement of the plastics material preforms.

Particularly preferably, a further heating device heats the produced plastics material preforms before they reach the forming device.

### BRIEF DESCRIPTION OF THE DRAWINGS

Further advantages and embodiments can be seen in the accompanying drawings, in which:

FIG. 1 shows a rough schematic representation of an apparatus according to the invention;

FIG. 2 shows a representation of a production device for producing plastics material preforms in a first view; and

FIG. 3 shows a further view of the production device shown in FIG. 2.

### DETAILED DESCRIPTION OF THE INVENTION

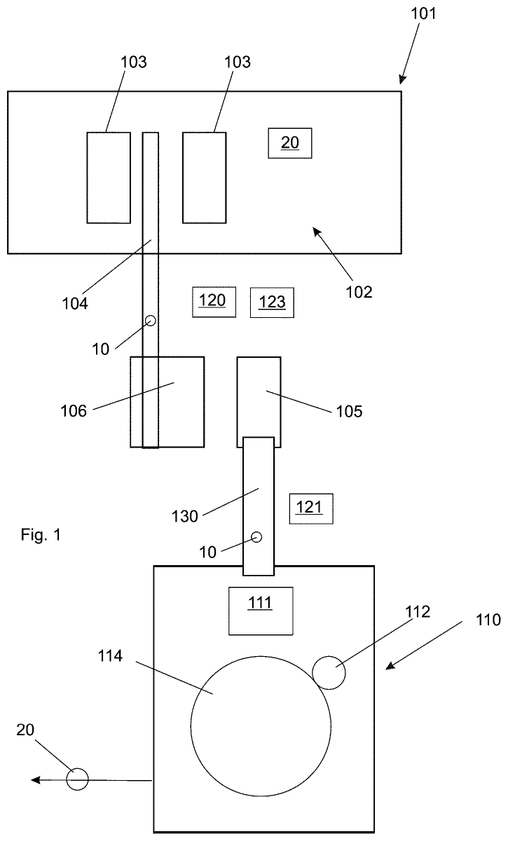

FIG. 1 shows a rough schematic representation of an apparatus 101 for producing plastics material containers. This apparatus 101 has a production device 102 that produces plastics material preforms 10. Preferably, this production device 102 is an injection molding machine. This production device 102 has a plurality of production units and in particular forming tools, each of which is suitable and intended for producing individual plastics material preforms 10.

Reference sign 104 schematically denotes a removal device that removes the injection-molded plastics material preforms 10 from the production units 102.

Reference sign 106 denotes a cooling device, in particular in the form of an after-cooler unit, that controls the temperature of and in particular cools the produced plastics material preforms 10. Preferably, the plastics material preforms are placed in this cooling device 106 and/or fed to the cooling device directly after their production.

An inspection device and in particular a first temperature detection device 120 is arranged along the transport path of the transport device 104, which first temperature detection device detects a temperature of the plastics material preforms or a value characteristic thereof and in particular detects them in a contactless manner. This first temperature detection device 120 is in particular suitable and intended for detecting the temperature of each individual plastics material preform 10. In addition to or instead of the temperature detection device, an inspection device can also be provided at this point that detects at least one value characteristic of the plastics material preform. Reference sign 123 denotes an evaluation device for evaluating the values measured by the temperature detection device.

Reference sign 130 denotes an assignment device that assigns, to each plastics material preform 10 whose temperature has been detected, a production unit 103 that produced said plastics material preform. The production device 101 preferably has at least one control device that is suitable and intended for controlling the individual production units, also on the basis of the measured temperatures of the individual plastics material preforms.

Reference sign 105 denotes a transport device and, in particular, a handling unit that receives the plastics material preforms 10 from the transport device 104.

Additionally or alternatively, the assignment device 130 is able to assign to each plastics material preform the forming station 112 that will form said plastics material preform into a plastics material container.

Preferably, therefore, the first temperature detection device is arranged between the production device and/or the individual production units and the cooling device 106 and/or the transport device 105.

Reference sign 121 denotes a further inspection device that detects at least one value characteristic of the plastics material preform inspected in each case. Here too, the value can preferably again be a value that is selected from a group of values that contains a geometry of the plastics material preforms, a color of the plastics material preforms, a humidity of the plastics material preforms, an IV value of the plastics material preforms, a temperature of the plastics material preforms or the like.

Preferably, these values are made available to a higher-level controller in order to control parameters of the entire apparatus.

Furthermore, a discharge device can be provided that (in particular depending on the aforementioned characteristic values) ensures that individual plastics material preforms are not transferred to the forming device 112.

Furthermore, a gap closing device (not shown) can be provided that closes gaps created by the discharge of individual plastics material preforms.

Reference sign 110 as a whole denotes a forming device that forms the plastics material preforms into plastics material containers 20.

In this case, first a heating device is preferably provided that heats the plastics material preforms to a temperature that is suitable for forming and, in particular, expanding them into the plastics material containers 20.

The forming device 110 preferably has a rotatable carrier 114 on which a plurality of forming stations 112 is arranged. These forming stations are preferably controllable independently of one another. Reference sign 111 denotes a heating device for heating the plastics material preforms.

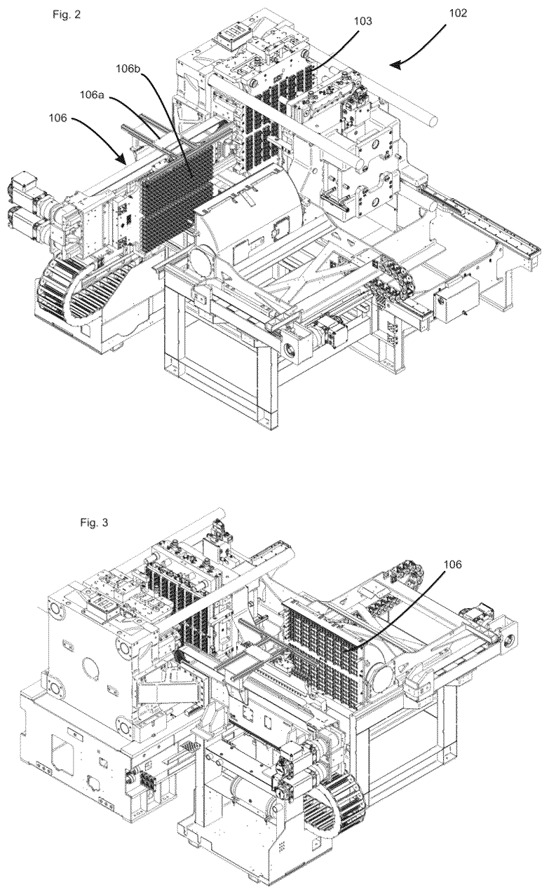

FIG. 2 and FIG. 3 show a first view of a production device 102 for producing the plastics material preforms. Reference sign 103 denotes a plurality of production units, each of which produces individual plastics material preforms.

Reference sign 106 denotes a cooling device for cooling the plastics material preforms. Reference sign 106a denotes a light barrier. Opposite this is a removal device for removing the plastics material preforms after the production process. Reference sign 106b denotes individual receiving devices for receiving the plastics material preforms.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for producing plastics material containers comprising a production device for producing plastics material preforms, wherein these plastics material preforms are configured for being formed into plastics material containers, wherein the production device has a plurality of production units, each of which is configured for producing plastics material preforms from a plastics material mass, comprising a forming device that is configured for forming the plastics material preforms produced by the production device into the plastics material containers, wherein the forming device has a plurality of forming stations, each of which is configured for applying a flowable medium to the plastics material preforms in order to form them into the plastics material containers, wherein the apparatus has at least one transport device that is configured for transporting the plastics material preforms separately from the production device to the forming device, at least in portions, wherein the apparatus further comprises a first temperature detection device that is configured for detecting a temperature of individual plastics material preforms produced by the production device
wherein
the apparatus further comprises at least one assignment device that is configured for assigning, to a plastics material preform whose temperature has been detected, the production unit that produced said plastics material preform and/or the forming station that will form said plastics material preform into a plastics material container.

2. The apparatus according to claim 1,
wherein
the first temperature detection device is arranged along the transport path along which the plastics material preforms are transported from the production device to the forming device.

3. The apparatus according to claim 1,
wherein
the apparatus has a cooling device for cooling the produced plastics material preforms.

4. The apparatus according to claim 1,
wherein
the production device has at least 20 production units and/or the forming device has at least 4 forming stations.

5. The apparatus according to claim 1,
wherein
the first temperature detection device has at least one camera.

6. The apparatus according to claim 1,
wherein
the apparatus has a second temperature detection device and/or a second inspection device that is configured for detecting the temperature or a characteristic value of at least a second region of the plastics material preforms, wherein the first region of the plastics material preforms and the second region of the plastics material preforms differ from one another.

7. The apparatus according to claim 1,
wherein
the transport device that transports the plastics material preforms from the production device to the forming device has a movable carrier that has a plurality of receiving device configured for receiving the plastics material preforms in the same orientation.

8. The apparatus according to claim 1,
wherein
the at least one transport device is configured for transporting the plastics material preforms continuously and separately from the production device to the forming device.

9. The apparatus according to claim 1,
wherein
the production units each have marking devices that are configured for providing the produced plastics material preforms with a marking that is characteristic at least of the production unit that produced the plastics material preform in question.

10. The apparatus according to claim 1,
wherein
the apparatus has at least one inspection device that is configured at least one characteristic value for the plastics material preforms.

11. A method for producing plastics material containers, wherein a production device produces plastics material preforms, wherein these plastics material preforms are configured for being formed into plastics material containers, wherein the production device has a plurality of production units, each of which produces the plastics material preforms from a plastics material mass, and a forming device that forms the plastics material preforms produced by the production device into the plastics material containers, wherein the forming device has a plurality of forming stations, each of which applies a flowable medium to the plastics material preforms in order to form them into the plastics material containers, and wherein at least one transport device transports the plastics material preforms separately from the production device to the forming device, at least in portions, and at least one first temperature detection device is provided that detects a temperature of individual plastics material preforms produced by the production device and/or values characteristic of such a temperature,
wherein
the first temperature detection device detects the temperature of a first region of the plastics material preforms and further at least one assignment device assigns, to at least one plastics material preform whose temperature has been detected by the first temperature detection device, the production unit that produced said plastics material preform and/or the forming station that will form said plastics material preform into a plastics material container.

12. The method according to claim 11,
wherein
a second temperature detection device detects the temperature of a second region of the plastics material preforms.

13. The method according to claim 11,
wherein
at least one temperature detection device detects the temperature of the first and/or second region of the plastics material preforms during a transport movement of the plastics material preforms.

14. The method according to claim 11,
and further comprising a further heating device heats the produced plastics material preforms before they reach the forming device.
